(19) United States
(12) Patent Application Publication
(10) Pub. No.: US 2005/0018698 A1
(43) Pub. Date: Jan. 27, 2005

(54) Device for access to at least one component of a networked system from outside or from at least one component of such a system outward

(76) Inventors: Gerrit de Boer, Hildesheim (DE); Rodolfo Mann Pelz, Hannover (DE)

Correspondence Address: KENYON & KENYON, ONE BROADWAY, NEW YORK, NY, 10004, US

(21) Appl. No.: 10/859,752

(22) Filed: Jun. 3, 2004

(30) Foreign Application Priority Data
Jun. 5, 2003 (DE) 10325447.1

(51) Int. Cl. H04L 12/56

(52) U.S. Cl. 370/401

(57) ABSTRACT

A device for access to at least one component of a networked system from outside or from at least one component of such a system outward, a network made up of a plurality of sub-networks being provided, the access from outside taking place via service gateways and a service gateway representing a first hierarchical level and the service gateways allocated to the sub-networks representing a second hierarchical level, the operators of the gateways of the second hierarchical level being positioned in the gateway of the first hierarchical level.

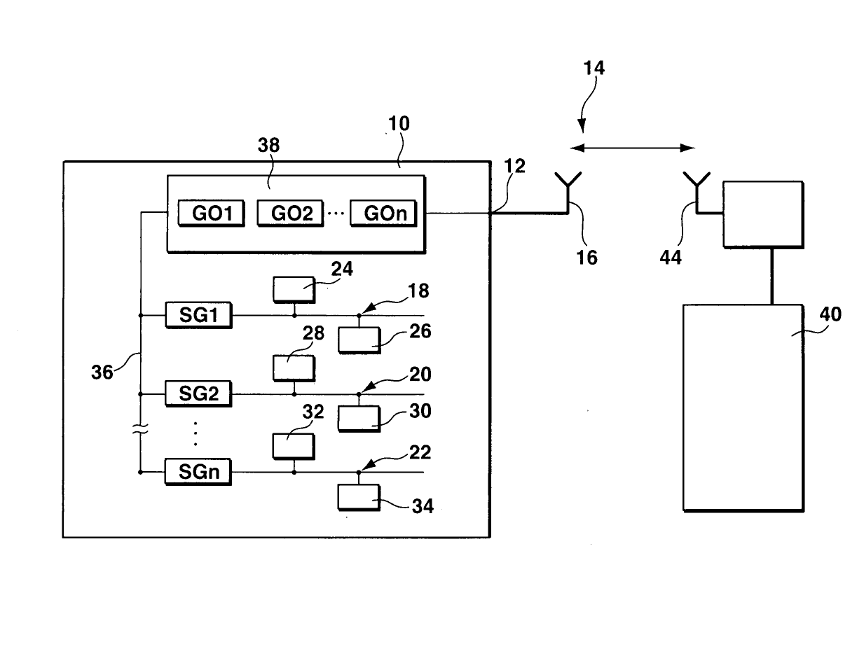

### FIELD OF THE INVENTION

The present invention relates to a device for access to at least one component of a networked system from outside and/or from at least one component of such a system outward, in particular to or from a component in a motor vehicle. In this connection, a component is an electrical or electronic unit or a device having an electrical or electronic control section.

### BACKGROUND INFORMATION

The increasing networking of components, also control units, in today's systems, in particular in motor vehicles, offers increasingly better options for influencing the functionalities of these components, for example better diagnostic capability in the event of an error, capabilities for remote control of functions and/or components, for remote maintenance and diagnosis and/or capabilities for supplementing/changing the functional scope of component. Furthermore, different services (e.g., video-on-demand, navigation data, etc.) or accesses to other networks, e.g., the Internet, may be implemented by a networked component. In this connection, there are concepts for reliable and secure access through radio-controlled action across any distance, for example, for implementing reliable and high-quality error analyses through remote diagnostics through a service center or a remote diagnostics server that has a corresponding diagnostics database. Furthermore, systems are implemented with which accesses from the networked system, into the Internet, for example, are possible from a component, e.g., an operator console. In accordance with these approaches, integrated communication systems, such as for example cell phones and/or GSM-supported telematics terminals, are used for application in communication systems integrated in the motor vehicle in order to carry out data transfer between the components and/or control units connected to a motor vehicle network and the server of the service center or other devices outside of the vehicle. German Patent Application No. DE 100 26 754 describes a proposal for such a system. There is no concrete implementation specified for such a system or the devices concerned in and outside of the motor vehicle.

Of particular importance in this connection are the gateway units within the networked system that access the outside and are accessed from outside and serve to connect the system to the outside world. Such gateways for access from outside to a network, in particular a motor vehicle network, will also be called Service Gateways (SG) in the following. Depending on the network characteristic, one or more such service gateways are provided, e.g., also to connect sub-networks. Depending on the design, these gateways are hardware units having an application framework executed as software, including basic functions, such as message routing, configuration management, life cycle management, user management, server functions for various applications, etc., or software modules having the above outlined properties that are distributed among one or more hardware platforms. As a rule, such a service gateway is platform-independent, for example, it is operated within the scope of a Java runtime environment, it is dynamically configurable and dynamically expandable by software components. Furthermore, the service gateway communicates with electronic components that are networked with this service gateway. A service gateway consequently represents a platform for many services based on communication between components and networks, in which, from the point of view of the allocated network or sub-network, the gateway represents the gate to the outside world, or for the outside world, it represents the gate to the interior of the network.

Furthermore, modules, i.e., gateway operators (GO), are provided for the administration of one or more service gateways, which check the provision and relaying of services for the individual service gateways. This task includes the download, activation, deactivation, updating or upgrading of application software found on the service gateway, the managing of access rights, etc. In other words, the gateway operator operates the service gateway(s) allocated to it and its services and maintains these. The function of a gateway operator is implemented here through software and hardware.

Using such systems, access from outside through at least one of these service gateways to a client (one or more components) is facilitated, with the objective of administering the at least one component and/or checking and/or providing at least one service or at least one application.

An open service gateway system (service gateway and gateway operator) is standardized within the scope of the OSGi (Open Service Gateway Initiative).

References to a concrete embodiment of such a service gateway system in a more complex network, e.g., in a network having at least one sub-network, in particular in a motor vehicle network, are not known from the cited related art. In particular, there are no references to a service gateway system in a network having components that are connected to one another via a network infrastructure (domains), with the objective of administering components of individual domains and/or providing service applications.

Access from outside includes remote access (for example, as part of remote diagnostics from a central server system) as well as local access, for example from laptops, diagnostic devices, etc. Correspondingly, outward access means access from the network outward.

### SUMMARY OF THE INVENTION

Through a hierarchical structure of a plurality of service gateways and the system of gateway operators for a lower hierarchical level in a higher hierarchical level, a central checking of the systems and functionalities in the network, in particular in the motor vehicle, is facilitated from a (main) service gateway of a higher hierarchical level. This is in particular advantageous in multimedia and/or telematics applications. In a system having two hierarchical levels, the central main service gateway represents the highest hierarchical level in the network.

Since the gateway operators of the lower hierarchical levels are positioned in the main service gateway, the gateway operators of the connected service gateways may be configured and replaced in a simple manner, making the entire system very flexible and suitable for extension. This is particularly significant for the practically relevant case when new components or services are introduced into the network. This is advantageous in motor vehicles in particular, since new or altered components (also software modules) and/or services may be introduced in the vehicle in the development as well as production or field phase.

The use of a standardized service gateway system (for example, OSGI), which facilitates product development, is especially advantageous in this connection.

A static and/or dynamic (i.e., during operation) configuration of the system functionalities is facilitated in an advantageous manner, the depth of the access from outside being limited only by the number of introduced hierarchical levels of service gateways. Furthermore, a redistribution of software components is facilitated, so that if necessary it will be possible to reduce the number of network elements, for example, control units. This occurs when software modules are relocated into the service gateway of this hierarchical level or a higher one.

### BRIEF DESCRIPTION OF THE DRAWING

The FIGURE illustrates a hierarchically positioned service gateway system in a network, preferably a motor vehicle network, which is connected via an air interface to the outside world, here to a central unit, for example a server unit.

### DETAILED DESCRIPTION

The FIGURE shows a network 10, which in the preferred exemplary embodiment is the network of a vehicle. Among other things, this is equipped outward with a connection 12 to an air interface 14, symbolized in the FIGURE by antenna 16. The vehicle network is equipped in the illustrated embodiment with three domains or sub-networks 18, 20, 22. Various components 24 to 34 are each connected thereto. The domains are positioned here in the same hierarchical level. A service gateway (SG1, SG2, SGN) is allocated to each sub-network. These service gateways are connected via a first input/output to a communication system 36, which connects the service gateways of a hierarchical level among themselves and to a service gateway 38 of a higher hierarchical level (here, the main service gateway). Furthermore, each service gateway has at least a second input/output, through which the particular service gateway is connected to the sub-network and the components contained therein. Main service gateway 38 is connected via a first input/output to communication system 36, via a second input/output to connection 12 to air interface 14.

Further infrastructure 40, for example devices of service or content providers, is found outside of network 10. These devices are for their part interfaced to air interface 14, symbolized by an antenna 44 in the illustrated exemplary embodiment. Devices 40 are connected via the air interface, for example via radio, to the vehicle network, and there to the main service gateway positioned in the highest hierarchical level. In this manner, access from outside to the vehicle network is provided. Conversely, this positioning allows communication from the network into the infrastructure.

As mentioned above, gateway operators that normally represent modules whose function is implemented through software and hardware are provided for administering and checking the particular service gateways. In view of the present procedure, it is important that the gateway operators for service gateways be positioned in a first hierarchical level in at least one service gateway of a higher hierarchical level. In the example shown, the gateway operators of service gateways SG1, SG2 and SGN connecting the sub-networks are implemented in the main service gateway (cf. GO1, GO2, GON). Accordingly, the gateway operator (HGO) of the main service gateway is not positioned in the vehicle network but is part of the external infrastructure.

As illustrated in the FIGURE, the procedure is therefore based on a hierarchical networking of a plurality of service gateways. Important components here are main service gateway 38, which is found in the vehicle, and its accompanying gateway operator, found in the external infrastructure, which for example represents the Internet, and which is interfaced to the vehicle network via a wireless radio link. Furthermore, there are other service gateways in the vehicle that are hierarchically below the main service gateway and whose accompanying gateway operators are part of the main service gateway. Consequently, the main service gateway checks the gateway operators of the service gateways of the lower hierarchical level.

The activities and the configuration of main service gateway (38) are therefore controlled by the main gateway operator (HGO) in the infrastructure, while the activities and configurations of the service gateways found in the second hierarchical level are controlled by the gateway operators provided in the main service gateway. As a result, convenient administration and control of the individual components in the subsystems, in particular of vehicle components, are possible, and the provision of services and applications available for all service gateways from outside is facilitated. The externally positioned main gateway operator therefore checks the gateway operators of the domains found thereunder through the main service gateway. The gateway operators themselves are configured in this manner from outside, and if necessary, exchanged or supplemented if new components or services have to be introduced into the vehicle, for example. The main gateway operator normally functions as a client for the gateway operators of the connected service gateways.

In other words, through corresponding commands in the infrastructure, e.g., at a provider, a service center of a vehicle manufacturer, etc., a corresponding instruction is given to the main gateway operator (HGO) to replace the software in one or more components when replacing, supplementing, or changing components in the vehicle. The main gateway operator sends software modules to one or more subordinate gateway operators to supplement or replace the software in the component or components concerned. In another example, this software is the software of the gateway operators. The main gateway operator configures via the radio interface the components and/or gateway operators of the service gateways concerned in the main service gateway of the vehicle network and replaces or supplements software modules of the gateway operator concerned, for instance.

In such an access from outside, because of the command from the provider (server or operator), corresponding instruction sequences and/or data from the main gateway operator are issued via the radio interface to the individual gateway operators in the main service gateway of the vehicle network, which are then further distributed there through corresponding control of the service gateways or executed according to the configuration of the gateway operators through corresponding control of the service gateways.

The service gateways in the motor vehicle are used for checking and controlling of networked electronic components from various domains, such as the vehicle body, drive train, telematics, multimedia, etc. The service gateway here is an integral component of application gateways that are used to couple different local networks or bus systems in the motor vehicle, such as for instance CAN, MOST, Bluetooth, WLAN, etc. Furthermore, the service gateway facilitates the relocation of applications, or application parts that are components of connected electronic components, to the service gateway.

It was shown above that the external gateway operator is found in the infrastructure, for example in the Internet. In other exemplary embodiments, it is found in a service center, for example in the form of a workshop device or a diagnostic device, or at home, for example in the form of a laptop or a PC.

Aside from the illustrated two-stage hierarchy, a multi-stage hierarchy, i.e., an enhanced cascade having other service gateway sublevels, is provided in other exemplary embodiments. In this case, the gateway operator of the lower level is found in a service gateway of a higher level, which is in turn controlled by the gateway operator from a level above it.

Aside from the application on a motor vehicle network, the illustrated procedure is also used in other networks having a plurality of sub-networks.

1. A device for accessing at least one component of a networked system from outside or from at least one component of a networked system outward, the device comprising:
an outward network interface; and
a network including sub-networks, each of the sub-networks including at least one component, at least one of the sub-networks including at least one second service gateway controlled by at least one gateway operator, the network further including at least one first service gateway through which the network is connected to the interface, the first service gateway forming a first hierarchical level, the at least one second service gateway of the at least one sub-network being allocated to the first service gateway of the first hierarchical level, the at least one second service gateway representing a second hierarchical level, the at least one gateway operator of the at least one second service gateway being allocated to the second hierarchical level in the first service gateway of the first hierarchical level.

2. The device according to claim 1, wherein the network is in a motor vehicle.

3. The device according to claim 1, wherein the service gateways at least one of administer and control networked electronic components from various domains.

4. The device according to claim 1, wherein the service gateways are components of application gateways that are used for coupling various local networks or bus systems.

5. The device according to claim 1, wherein in the first service gateway, at least parts of application software are relocated from electronic components connected in a particular sub-network.

6. The device according to claim 1, wherein the first service gateway is used for a configuration of gateway operators under it.

7. The device according to claim 1, wherein the first service gateway of the first hierarchical level is in the Internet.

8. The device according to claim 1, wherein the first service gateway of the first hierarchical level is in a service center.

9. The device according to claim 1, wherein the first service gateway of the first hierarchical level is in a vehicle.
